(19) United States
(12) Patent Application Publication
(10) Pub. No.: US 2007/0285218 A1
(43) Pub. Date: Dec. 13, 2007

(54) OCCUPANT ABANDONMENT SENSOR FOR AUTOMOTIVE VEHICLES

(75) Inventors: Douglas D. Fletcher, Canton, MI (US); Kyle D. Lasenby, West Bloomfield, MI (US); David V. Mahoney, Austin, TX (US); Patrick C. Howard, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/423,379

(22) Filed: Jun. 9, 2006

(51) Int. Cl. B60Q 1/00

(52) U.S. Cl. 340/457

(57) ABSTRACT

Presence of an occupant in a vehicle is sensed. Furthermore, at least one occupant exposure condition in the vehicle is sensed. If there is an occupant in the vehicle, a signal is sent as a function of the at least one occupant exposure condition in the vehicle.

### BACKGROUND

Occupant sensors for vehicles are used in a variety of different applications. For example, such sensors can be used to sense if an occupant is wearing a seat belt and/or whether or not an air bag should be deployed during a crash. Although these sensors can be useful, current sensors do not address detecting dangerous or otherwise hazardous conditions within the vehicle with respect to an abandoned occupant.

### SUMMARY

In one aspect of the concepts presented herein, a method comprises sensing presence of an occupant in a vehicle. Furthermore, at least one occupant exposure condition in the vehicle is sensed. If there is an occupant in the vehicle, a signal is sent as a function of the at least one occupant exposure condition in the vehicle.

In another aspect, a system for sensing conditions in a vehicle comprises an occupant sensing module adapted to sense presence of an occupant in the vehicle and an occupant exposure sensing module adapted to monitor at least one occupant exposure condition of the vehicle. A signaling module is coupled to the occupant sensing module and the occupant exposure sensing module. The signaling module is further adapted to provide a signal if the occupant sensing module indicates that an occupant is in the vehicle as a function of the at least one occupant exposure condition.

This summary is not intended to describe each disclosing embodiment or every implementation of the concepts presented herein. The figures and the description that follows more particularly exemplify embodiments.

### BRIEF DESCRIPTION OF THE DRAWINGS

The concepts presented herein will be further explained with reference to the attached figures, wherein like structure or system elements can be referred to by like reference numerals throughout the several views.

FIG. 1 is a flow diagram of a method for sensing occupant presence and occupant exposure conditions in a vehicle and sending a signal.

FIG. 2 is a block diagram of components in an occupant abandonment sensing system.

FIG. 3 is a schematic diagram of a vehicle.

While the above-identified figures set forth one or more embodiments of the present invention, other embodiments are also contemplated, as noted herein. In all cases, concepts presented herein describe the invention by way of representation and not by elimination. It should be understood that numerous other modifications and embodiments can be devised by those skilled in the art which fall within the scope and spirit of the principles of this invention.

### Glossary

The terms set forth below will have meanings as defined:

“occupant exposure condition” means a condition or related circumstance to which a person or object inside the vehicle can potentially be exposed.

“occupant” means a person and/or object inside a vehicle.

“vehicle” means a structure for transporting persons and/or things, such as, for example, a car, truck, or van.

### DETAILED DESCRIPTION

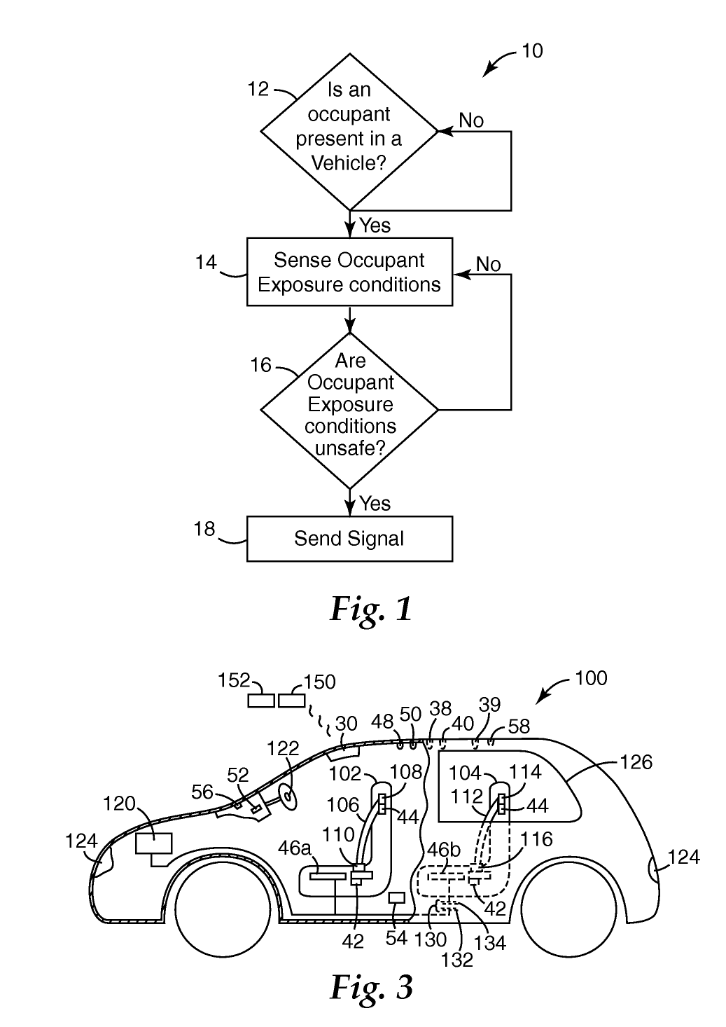

FIG. 1 is a flow diagram of a method 10 for sensing presence of an occupant in a vehicle, sensing occupant exposure conditions and providing an appropriate signal. Any single event and/or combination of events can trigger the start of method 10. Method 10 can start when an ignition is on or after the ignition for the vehicle has been turned off. Method 10 begins at step 12, wherein it is determined whether an occupant is present in the vehicle. As discussed below, an occupant sensing module can be used to sense presence of an occupant. For example, the occupant sensing module can be coupled to one or more sensors such as a motion sensor, an audio sensor, a seat belt buckle sensor, a vision sensor, a seat belt tensioner sensor and/or a seat occupant sensor. If there is no occupant in the vehicle, method 10 remains at step 12.

If there is an occupant in the vehicle, method 10 proceeds to step 14, wherein occupant exposure conditions are sensed. These occupant exposure conditions are indicative of conditions that have potential to cause a hazardous or dangerous situation in the vehicle. There are several different occupant exposure conditions that can be sensed. For example, a temperature, a humidity reading, an ignition status, and a window position status can all be sensed at step 14.

At step 16, it is determined whether the occupant exposure conditions sensed in step 14 are unsafe. For example, the occupant exposure condition can be compared to one or more preset thresholds such as a temperature, a humidity, a position of windows in the vehicle, a status of the ignition and/or a time. If it is determined that the conditions are safe, method 10 returns to step 14 to continually sense and monitor the occupant exposure conditions in the vehicle. However, if the conditions are unsafe, method 10 proceeds to step 18 wherein a signal is sent that is indicative of an unsafe condition in a vehicle. The signal can include, but is not limited to, one or more of the following: flashing a light of the vehicle, honking a horn of the vehicle, transmitting a wireless signal to a computing device, dialing a phone number and/or contacting an emergency service. Other approaches to signaling can also be used.

FIG. 2 is a block diagram of components in a occupant abandonment sensing system 30. System 30 includes an occupant sensing module 32, an occupant exposure sensing module 34 and a signaling module 36. Occupant sensing module 32 is adapted to receive signals from one or more occupant sensors provided in a vehicle. For example, occupant sensing module 32 can be coupled to a motion sensor 38, a vision sensor 39, an audio sensor 40, a seat belt buckle sensor 42, a seat belt tensioner sensor 44 and/or a seat occupancy sensor 46. Seat belt tensioner sensor 44 can be used to measure displacement of a seat belt. In an alternative embodiment, seat belt tensioner sensor 44 can be used to measure load on the seat belt. Occupant exposure sensing module 34 can be coupled to one or more occupant exposure condition sensors including a temperature sensor 48, a humidity sensor 50, an ignition sensor 52, a window position sensor 54, a timer 56 and/or a chemical sensor 58. If desired, the sensors can be mated to wireless communication technology (e.g., radio frequency identification (RFID) technology or Bluetooth) and interrogated remotely.

Motion sensor 38 can be any type of motion sensor adapted to detect motion within the vehicle. For example, motion sensor 38 can be an infrared energy detector. Vision sensor 39 can be any type of vision sensor such as a video camera. If motion or a visual effect is detected, a signal can be sent to occupant sensing module 32 indicative of the motion or effect. Audio sensor 40 can be any type of audio sensor to detect sound within the vehicle. For example, audio sensor 40 can be an active or passive sensing system, as understood by these skilled in the art. If audio is detected, a signal is sent to occupant sensing module 32 indicative of the audio.

Seat belt buckle sensor 42 and seat belt tensioner sensor 44 can be coupled to associated seat belts within the vehicle. If the associated seat belt is buckled and/or the seat belt experiences tension and/or a change in tension, a signal can be sent to occupant sensing module 32 that an occupant is present in the vehicle. Seat occupancy sensor detects whether an occupant is in a particular seat. The seat occupancy sensor 46 can be any type of sensor such as a weight-based sensor (i.e. including strain gauges, pressure bladder, etc.) or a capacitive seat sensor. One particular seat sensor is described in co-pending patent application titled “Vehicle Seat Sensor Assembly”, filed on the same day as the present application, the contents of which are hereby incorporated by reference.

Temperature sensor 48 can be any type of temperature sensor and be adapted to send a signal to occupant exposure sensing module 34 based on one or more set temperature thresholds. For example, if the temperature within the vehicle is too hot or too cold, a signal can be generated by occupant exposure sensing module 34. Humidity sensor 50 can operate in a similar manner. If humidity within the vehicle is above or below set humidity thresholds, a signal can be generated by occupant exposure sensing module 34 indicative thereof. The signals are subsequently sent to the signaling module 36 for analysis and execution.

Ignition sensor 52 is coupled to an ignition of the vehicle and provides a signal indicative of a status of the ignition. Window position sensor 54 is coupled to one or more windows of the vehicle and can provide a status indicative of position of one or more windows in the vehicle. For example, if one or all the windows are closed, a closed status can be sent to occupant exposure sensing module 34. Timer 56 can be provided to indicate a period of time for which an occupant has been abandoned in the vehicle. For example, timer 56 can send a signal every 15 minutes, half hour and/or hour to indicate that an occupant has been abandoned for a period of time. Chemical sensor 58 senses presence of harmful chemicals and/or gases within the vehicle. In one embodiment, chemical sensor 58 can sense for carbon monoxide. Other embodiments might include chemical sensors 58 that can sense, for example, alcohol, ethanol, hydrogen, gasoline, or other gases or odors emanating from the vehicle.

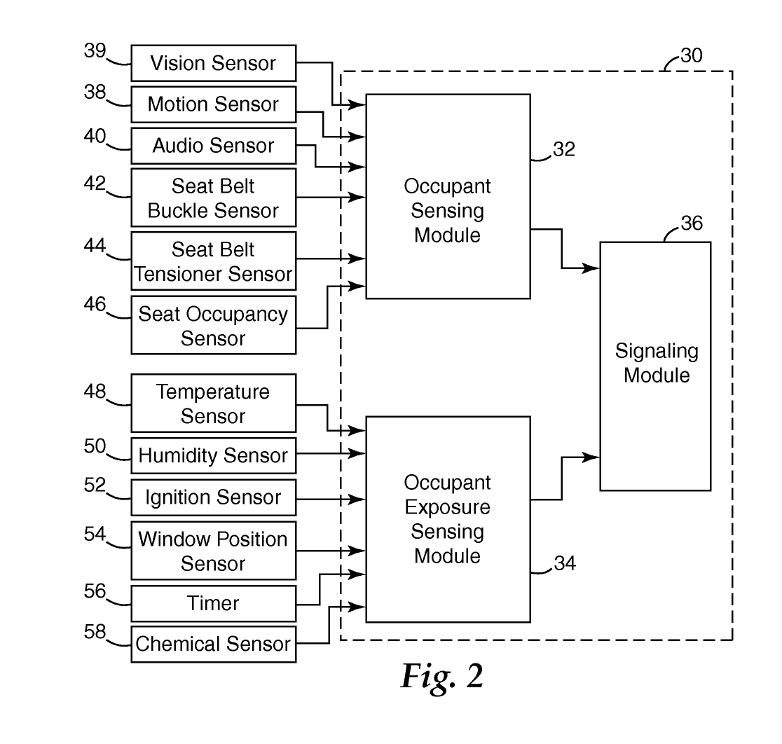

FIG. 3 is a schematic diagram of a vehicle 100 including occupant abandonment sensing system 30. Occupant abandonment sensing system 30 can be located at various positions throughout vehicle 100. Vehicle 100 includes front seat 102 and rear seat 104. Reference will be made to a single front seat 102 and a single rear seat 104. However, multiple front seats and multiple rear seats are typically employed in vehicle 100, and each seat may have one or more associated sensors discussed below. Front seat 102 includes an associated seat belt 106. Seat belt 106 is coupled to a tensioner 108 and a buckle 110 for securing the seat belt. Similarly, back seat 104 includes an associated seat belt 112 coupled to a tensioner 114 and buckle 116. Buckles 110 and 116 can be coupled to one or more seat belt buckle sensors 42. Additionally, tensioners 108 and 114 can be coupled to seat belt tensioner sensors 44. Front seat 102 includes a seat occupancy sensor 46a and rear seat 104 includes a seat occupancy sensor 46b. Furthermore, vehicle 100 includes a battery 120, a horn 122, lights 124 and one or more windows 126.

Battery 120 provides power to several components in vehicle 100. For example, battery 120 can provide power to system 30, motion sensor 38, vision sensor 39, audio sensor 40, seat belt buckle sensor 42, seat belt tensioner sensor 44, seat occupancy sensors 46a and 46b and chemical sensor 58. Battery 120 can be directly coupled to seat occupancy sensor 46a using a suitable lead. Likewise, battery 120 can be directly coupled to seat occupancy sensor 46b. However, in some instances it may be desired for rear seat 104 to be removable from a floor of vehicle 100. In this instance, power from battery 120 can be supplied through an inductive coupling 130. Inductive coupling 130 allows power to be transmitted between circuits 132 and 134, for example through a shared magnetic field. Thus, circuit 134 can be physically separated from circuit 132 during removal of seat 104 but can be easily recoupled to circuit 132 by placement of seat 104 in its place within vehicle 100.

Furthermore, any of the sensors can be equipped to send information wirelessly to system 30. For example, an internal sensor can transmit a wireless signal to system 30. The wireless signal can be, for example, a Bluetooth® signal, an RFID signal, an inductive digital signal and/or an inductive analog signal. In some cases, the signals can be transmitted via inductive couplings and/or capacitive couplings, as understood by those skilled in the art.

Battery 120 further provides power to temperature sensor 48, humidity sensor 50, ignition sensor 52, window position sensor 54 and timer 56. Additionally, battery 120 provides power to horn 122, lights 124 and windows 126. Wiring provided throughout vehicle 100 can be used to deliver power to these components. When occupant abandonment sensing system 30 determines that unsafe conditions exist in vehicle 100 and an occupant is present in vehicle 100, a signal is sent. As discussed above, the signal can be one or more of honking horn 122, flashing one or more of lights 124 and/or providing a wireless signal. For example, a wireless signal can be sent or transmitted from signaling module 36 to an associated computing device 150 or an emergency service 152. Computing device 150 can be a phone, computer, personal digital assistant or the like. For example, emergency service 152 can be a commercial service such as OnStar® or a public service such as 911.

Although the present invention has been described with reference to several alternative embodiments, workers skilled in the art will recognize the changes may be made in form and detail without departing from the spirit and scope of the invention. For instance, any number of occupant sensors can provide a signal to an occupant sensing module. Furthermore, any number of occupant exposure condition sensors can be provided to provide a signal to an occupant exposure sensing module. Moreover, features shown and describe with respect to one embodiment may be combined with features of other embodiments, as desired.

What is claimed is:

1. A method comprising:
sensing presence of an occupant in a vehicle;
sensing at least one occupant exposure condition in the vehicle; and
if there is an occupant in the vehicle, then sending a signal as a function of the at least one occupant exposure condition in the vehicle.

2. The method of claim 1 wherein the at least one occupant exposure condition includes at least one of an ignition status of the vehicle and a window position and a door position.

3. The method of claim 1 wherein the at least one occupant exposure condition includes at least one of a temperature status, a humidity status, a chemical status and a time period.

4. The method of claim 1 wherein the sensing presence step comprises using at least one of a capacitive sensor, a motion sensor, an audio sensor, a vision sensor, a seat belt buckle sensor and a seat belt tensioner sensor.

5. The method of claim 4 wherein at least one of the sensors is adapted to transmit a wireless signal to at least one of an occupant sensing module and an occupant exposure sensing module.

6. The method of claim 5 wherein the wireless signal is selected from a group consisting of a Bluetooth® signal, a radio frequency identification signal, a capacitive signal, an inductive digital signal and an inductive analog signal.

7. The method of claim 1 wherein sending the signal includes at least one of flashing lights of the vehicle and honking a horn of the vehicle.

8. The method of claim 1 wherein sending the signal includes transmitting a wireless signal to a computing device.

9. The method of claim 8, wherein the computing device is selected from a group consisting of a phone, a computer and a personal digital assistant.

10. The method of claim 1 wherein sending the signal includes at least one of dialing a phone number and contacting an emergency service.

11. A system for sensing conditions in a vehicle comprising:
an occupant sensing module adapted to sense presence of an occupant in the vehicle;
an occupant exposure sensing module adapted to monitor at least one occupant exposure condition of the vehicle; and
a signaling module coupled to the occupant sensing module and the occupant exposure sensing module and adapted to provide a signal if the occupant sensing module indicates that an occupant is in the vehicle as a function of the at least one occupant exposure condition.

12. The system of claim 11 wherein the at least one occupant exposure condition includes at least one of a temperature status, a humidity status, a chemical status and a time period.

13. The system of claim 11 wherein the at least one occupant exposure condition includes at least one of an ignition status of the vehicle and a window position and a door position.

14. The system of claim 11 wherein the occupant sensing module is adapted to sense presence of an occupant using a signal from at least one of a capacitive sensor, a motion sensor, a vision sensor, an audio sensor, a seat belt buckle sensor and a seat belt tensioner sensor.

15. The system of claim 14 wherein at least one of the sensors is adapted to transmit a wireless signal to at least one of the occupant sensing module and the occupant exposure sensing module.

16. The system of claim 15 wherein the wireless signal is selected from a group consisting of a Bluetooth® signal, a radio frequency identification signal, a capacitive signal, an inductive digital signal and an inductive analog signal.

17. The system of claim 11 wherein the signal includes at least one of flashing lights of the vehicle and honking a horn of the vehicle.

18. The system of claim 11 wherein the signaling module is adapted to transmit a wireless signal to a computing device.

19. The system of claim 18 wherein the computing device is selected from a group consisting of a phone, a computer and a personal digital assistant.

20. The system of claim 11 wherein the signaling module is adapted to perform at least one of dialing a phone number and contacting an emergency service.

21. A vehicle, comprising:
an occupant sensing module adapted to sense presence of an occupant in a vehicle;
occupant exposure sensing module adapted to monitor at least one occupant exposure condition of the vehicle; and
a signaling module coupled with an occupant sensing module and the occupant exposure sensing module and adapted to provide a signal if the occupant sensing module indicates that an occupant is in the vehicle as a function of at least one occupant exposure condition.

22. The vehicle of claim 21 and further comprising at least one of a motion sensor, a vision sensor, an audio sensor, a capacitive sensor, a seat belt buckle sensor and a seat belt tension sensor operably coupled to the occupant sensing module to provide a signal indicative of presence of an occupant in the vehicle.

23. The vehicle of claim 21 and further comprising at least one of a temperature sensor, a humidity sensor, an ignition sensor, a window position sensor, a chemical sensor and a timer operably coupled to the occupant exposure sensing module to provide a signal indicative of the at least one occupant exposure condition of the vehicle.

24. The vehicle of claim 21 wherein the signaling module is further adapted to perform at least one of flashing lights of the vehicle, honking a horn of the vehicle, transmitting a wireless signal to a computing device, dialing a phone number and contacting an emergency service.
